(19) United States
(12) Patent Application Publication
(10) Pub. No.: US 2021/0221957 A1
(43) Pub. Date: Jul. 22, 2021

(54) HYDROPHILIC AND OXYGEN PERMEABLE POLYMER MATERIAL AND PREPARATION PROCESS THEREOF

(71) Applicant: APEXLENS CO., LTD., HSINCHU CITY (TW)

(72) Inventors: Chien-Yen HUANG, Pingtung City (TW); Jia-Min CHIOU, New Taipei City (TW); Pai-Tsun CHEN, Taoyuan City (TW)

(73) Assignee: APEXLENS CO., LTD., HSINCHU CITY (TW)

(21) Appl. No.: 17/220,652

(22) Filed: Apr. 1, 2021

Related U.S. Application Data
(63) Continuation-in-part of application No. 16/433,921, filed on Jun. 6, 2019.

(51) Int. Cl. C08G 77/452; C08G 77/442; G02B 1/04

(52) U.S. Cl. CPC C08G 77/452; G02B 1/043; C08G 77/442

(57) ABSTRACT

Disclosed is a hydrophilic and oxygen permeable polymer material, including alicyclic isocyanate, a grafted repeating unit with silicon-containing monomer, and a first hydrophilic monomer. The grafted repeating unit has an average molecular weight less than or equal 5,000, and is in an amount of 20-60% based on the total weight of the hydrophilic and oxygen permeable polymer material. The first hydrophilic monomer is in an amount of 1-40% based on the total weight of the hydrophilic and oxygen permeable polymer material. Also disclosed is a method for preparing the hydrophilic and oxygen permeable polymer material.

### CROSS-REFERENCE TO RELATED APPLICATION

This application is a continuation-in-part of U.S. patent application Ser. No. 16/433,921, filed on Jun. 6, 2019. The entirety of the above-mentioned patent application is hereby incorporated by reference herein and made a part of this specification.

### BACKGROUND OF THE INVENTION

### 1. Field of the Invention

The present invention generally relates to a hydrophilic polymer material, and more specifically to a hydrophilic polymer material with high oxygen permeability having alicyclic isocyanate, a grafted repeating unit with silicon-containing monomer, and a first hydrophilic monomer for manufacturing soft contact lens to protect eyes from dry environment. The present invention also relates to a method for preparing the hydrophilic polymer material with high oxygen permeability.

### 2. The Prior Arts

Recently, contact lenses have become more popular due to easy use and high reliability, but users should avoid wearing the contact lenses too long because corneas do not acquire sufficient oxygen. Thus, one of the key features of the contact lenses is high oxygen permeability.

In the prior arts, some oxygen permeable materials like silicone hydrogel have been developed for the contact lenses, which may prevent irritation due to cornea hypoxia even after a prolonged wearing of the contact lenses.

However, one of the shortcomings in the prior arts is that its optical stability is not sufficient and chemical endurance is weak. As a result, the contact lenses become risky and its transparency is degraded. Another shortcoming is that weather, abrasion and hydrolysis endurance is also poor, and the contact lenses are not suitably worn for a prolonged period of time.

Therefore, it is greatly needed to provide a new hydrophilic polymer material high oxygen permeability for contact lens to protect eyes from adverse environment, thereby overcoming the above problems in the prior arts.

### SUMMARY OF THE INVENTION

The primary object of the present invention is to provide a hydrophilic and oxygen permeable polymer material having a structure presented by formula A-(B)_{b}-C, wherein A is alicyclic isocyanate, B is a silicon-containing monomer modified by grafting as a repeating unit, b is an integer of 1-30, (B)_{b} has an average molecular weight less than or equal 5,000, and is in an amount of 20-60% based on the total weight of the hydrophilic and oxygen permeable polymer material, C is a first hydrophilic monomer and in an amount of 1-40% based on the total weight of the hydrophilic and oxygen permeable polymer material; wherein the alicyclic isocyanate comprises 3-isocyanatomethyl-3,5,5-trimethylcyclohexyl isocyanate (IPDI); wherein (B)_{b} is polydimethylsiloxane or poly[oxy(dimethylsilylene)](PDMS); wherein the IPDI includes two NCO groups, which have different chemical activity.

Specifically, the first hydrophilic monomer comprises at least one of allyl alcohol, 2-methyl-2-propen-1-ol, 2-allylethyl alcohol, 2-(dimethylamino)ethyl methacrylate, 2-(dimethylamino)ethyl acrylate, 4-penten-2-ol, N-[3-(dimethylamino)propyl]methacrylamide, hydroxypropyl methacrylate, poly(propylene glycol) methacrylate, 3-methyl-2-buten-1-ol, trans,trans-2,4-hexadien-1-ol, 2-hydroxypropyl methacrylamide, poly(L-lactide) methacrylate, poly(ethylene glycol) methacrylate, 1,2-ethanediol mono(2-methylpropenoate), glycol methacrylate (HEMA), N-vinyl-2-pyrrolidinone (NVP), N,N-dimethylacrylamide (DMA), and trimethylopropane trimethacrylate (TMPTMA).

Specifically, the silicon-containing monomer comprises at least one of 3-methacryloxypropyl tris(trimethylsiloxy)silane, 3-acryloxypropyl tris(trimethylsiloxy)silane, 3-acrylamidopropyl tris(trimethylsiloxy)silane, 3-methacrylamidopropyl tris(trimethylsiloxy)silane, 3-vinyl carbamatepropyl tris(trimethylsiloxy)silane, and (3-methacryloxy-2-hydroxyprpoxy) propylbis (trimethylsiloxy)methylsilane.

Specifically, the hydrophilic and oxygen permeable polymer material further comprises a second hydrophilic monomer, and the second hydrophilic monomer comprising at least one of allyl alcohol, 2-methyl-2-propen-1-ol, 2-allylethyl alcohol, 2-(dimethylamino)ethyl methacrylate, 2-(dimethylamino)ethyl acrylate, 4-penten-2-ol. N-[3-(dimethylamino)propyl]methacrylamide, hydroxypropyl methacrylate, poly(propylene glycol) methacrylate, 3-methyl-2-buten-1-ol, trans,trans-2,4-hexadien-1-ol, N-3-sulfopropyl-N,N-dimethyl ammonium)ethyl methacrylate, N,N-dimethylacrylamide (DMA), poly(ethylene glycol) methacrylate, 2-hydroxypropyl methacrylamide, (methacryloyloxy)ethyl]dimethylammonio]propionate, 2-hydroxyethyl methacrylate, poly(L-lactide) methacrylate, phosphobetaine methacrylate, poly(ethylene glycol) methacrylate, 1,2-ethanediol mono(2-methylpropenoate), glycol methacrylate (HEMA), N-vinyl-2-pyrrolidinone (NVP), and trimethylopropane trimethacrylate (TMPTMA).

Another object of the present invention is to provide a method for preparing the aforementioned hydrophilic and oxygen permeable polymer material, comprising: (a) mixing and stirring 3-isocyanatomethyl-3,5,5-trimethylcyclohexyl isocyanate (IPDI) with polydimethylsiloxane or poly[oxy(dimethylsilylene)](PDMS); (b) producing a first interim polymer represented by a formula as:

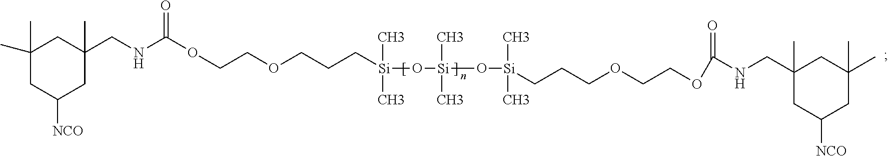

(c) mixing and stirring OCN-PDMS-PU-NCO with the first hydrophilic monomer to induce a polymerization, and a second interim polymer is produced represented by a formula as:

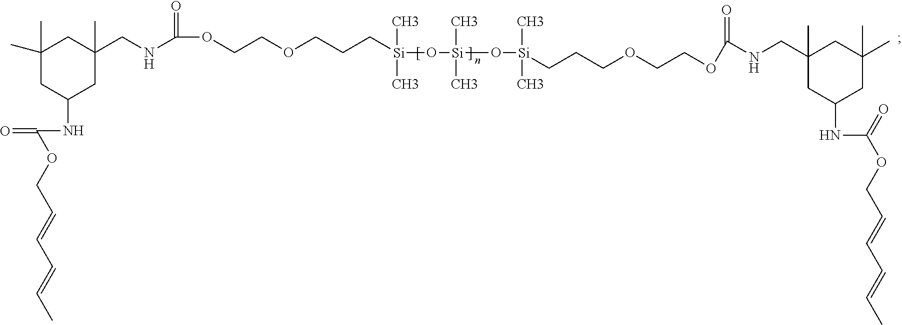

and (d) mixing and stirring the second interim polymer with the first hydrophilic monomer to obtain the hydrophilic and oxygen permeable polymer material.

Specifically, the first hydrophilic monomer in step (c) is trans,trans-2,4-hexadien-1-ol.

Specifically, the first hydrophilic monomer in step (d) comprises at least one of 1,2-ethanediol mono(2-methylpropenoate), glycol methacrylate (HEMA), N-vinyl-2-pyrrolidinone (NVP), N,N-dimethylacrylamide (DMA), and trimethylopropane trimethacrylate (TMPTMA).

Specifically, the mixing and stirring in step (a) is performed at 20-50° C.

The polymer material of the present invention demonstrates high oxygen permeability is suitably applied to contact lens for further protecting eyes from adverse environment.

### DETAILED DESCRIPTION OF THE PREFERRED EMBODIMENT

The hydrophilic and oxygen permeable polymer material according to the embodiment of the present invention has a structure presented by formula A-(B)_{b}-C, wherein A is alicyclic isocyanate, B is a silicon-containing monomer modified by grafting as a repeating unit, b is an integer of 1-30, and, C is a first hydrophilic monomer.

Specifically, (B)_{b} is preferably polydimethylsiloxane or poly[oxy(dimethylsilylene)](PDMS), and has an average molecular weight less than or equal 5,000, and is in an amount of 20-60% based on the total weight of the hydrophilic and oxygen permeable polymer material. Further, the first hydrophilic monomer is in an amount of 1-40% based on the total weight of the hydrophilic and oxygen permeable polymer material.

It is preferred that the first hydrophilic monomer comprises at least one of allyl alcohol, 2-methyl-2-propen-1-ol, 2-allylethyl alcohol, 2-(dimethylamino)ethyl methacrylate, 2-(dimethylamino)ethyl acrylate, 4-penten-2-ol, N-[3-(dimethylamino)propyl]methacrylamide, hydroxypropyl methacrylate, poly(propylene glycol) methacrylate, 3-methyl-2-buten-1-ol, trans,trans-2,4-hexadien-1-ol, 2-hydroxypropyl methacrylamide, poly(L-lactide) methacrylate, poly(ethylene glycol) methacrylate, 1,2-ethanediol mono(2-methylpropenoate), glycol methacrylate (HEMA), N-vinyl-2-pyrrolidinone (NVP), and N,N-dimethylacrylamide (DMA).

The chemical formula of HEMA is as follows.

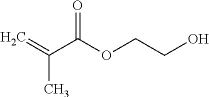

The chemical formula of NVP is as follows.

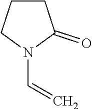

The chemical formula of DMA is as follows.

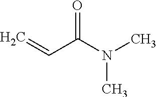

Furthermore, the chemical formula for the above first hydrophilic monomer is summarized in Table 1.

TABLE 1
allyl alcohol

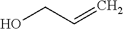

2-(dimethylamino)ethyl
methacrylate

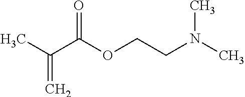

(dimethylamino)propyl]
methacrylamide

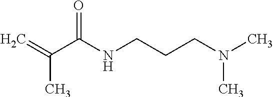

2-methyl-2-propen-1-ol

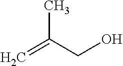

2-(dimethylamino)
ethyl acrylate

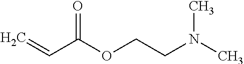

hydroxypropyl methacrylate

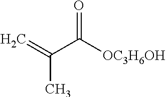

2-allylethyl alcohol

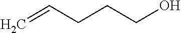

4-penten-2-ol

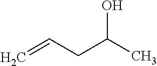

poly(propylene glycol)
methacrylate

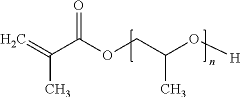

3-methyl-2-buten-1-ol

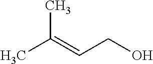

2-hydroxypropyl
methacrylamide

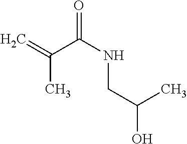

PLA methacrylate

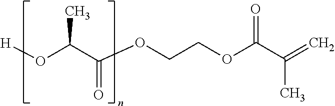

trans,trans-2,4-hexadien-1-ol

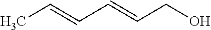

poly(ethylene glycol)
methacrylate

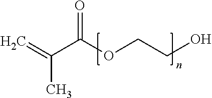

poly(ethylene glycol)
methacrylate(PEGMA)

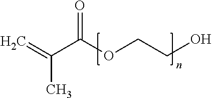

More specifically, the silicon-containing monomer comprises at least one of 3-methacryloxypropyl tris(trimethylsiloxy)silane, 3-acryloxypropyl tris(trimethylsiloxy)silane, 3-acrylamidopropyl tris(trimethylsiloxy)silane, 3-methacrylamidopropyl tris(trimethylsiloxy) silane, 3-vinyl carbamatepropyl tris(trimethylsiloxy)silane, and (3-methacryloxy-2-hydroxyprpoxy) propylbis (trimethylsiloxy)methylsilane.

The above silicon-containing monomer is further clearly expressed at Table 2 below.

TABLE 2
3-(trimethoxysilyl)propylmethacrylate
H₂C═C(CH₃)CO₂(CH₂)₃Si(OCH₃)₃)

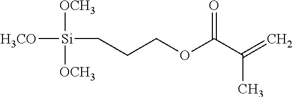 [SMILES: C=C(C)C(=O)OCCC[Si](OC)(OC)OC]

3-methacrylamidopropyl
tris(trimethylsiloxy)silane
C₁₆H₃₉NO₄Si₄)

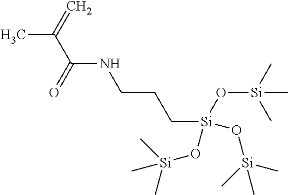 [SMILES: C=C(C)C(=O)NCCC[Si](O[Si](C)(C)C)(O[Si](C)(C)C)O[Si](C)(C)C]

3-(trimethoxysilyl)propyl acrylate
H₂C═CHCO₂(CH₂)₃Si(OCH₃)₃)

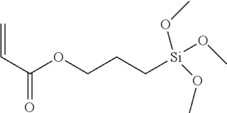

3-methacryloxypropylmethyl
dimethoxysilane
C₁₀H₂₀O₄Si

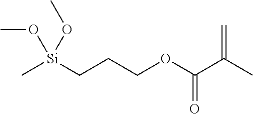

lamidopropyl tris(trimethylsiloxy)silane
C15H37NO4Si4

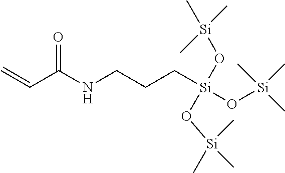 [SMILES: C=CC(=O)NCCC[Si](O[Si](C)(C)C)(O[Si](C)(C)C)O[Si](C)(C)C]

triethoxyvinylsilane
H₂C═CHSi(OC₂H₅)₃)

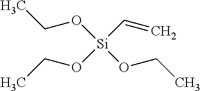

Preferably, the alicyclic isocyanate comprises 3-isocyanatomethyl-3,5,5-trimethylcyclohexyl isocyanate (isophorone diisocyanate, IPDI), which is represented by a formula:

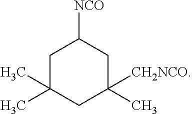

Specifically, IPDI has lower reactivity and vapor pressure than aromatic isocyanate, and includes two NCO groups, which have different chemical activity. The NCO group on the cyclohexane ring has stronger reactivity by 1.3-2.5 times than the other NCO group bonded with a methyl group, which suffers from retardation due to the cyclohexane ring and the methyl group. As a result, IPDI has the reaction rate with the hydroxyl group faster than HDI by 4-5 times.

The polyurethane resin made from IPDI demonstrates excellent optical stability and chemical endurance, and is suitably applied to high end polyurethane coating with optical and weather endurance, and elastomer with abrasion and hydrolysis endurance.

In addition, the hydrophilic and oxygen permeable polymer material further comprises a second hydrophilic monomer, and the second hydrophilic monomer preferably comprises at least one of allyl alcohol, 2-methyl-2-propen-1-ol, 2-allylethyl alcohol, 2-(dimethylamino)ethyl methacrylate, 2-(dimethylamino)ethyl acrylate, 4-penten-2-ol. N-[3-(dimethylamino)propyl[methacrylamide, hydroxypropyl methacrylate, poly(propylene glycol) methacrylate, 3-methyl-2-buten-1-ol, trans,trans-2,4-hexadien-1-ol, N-3-sulfopropyl-N,N-dimethyl ammonium)ethyl methacrylate, N,N-dimethylacrylamide (DMA), poly(ethylene glycol) methacrylate, 2-hydroxypropyl methacrylamide, poly(ethylene glycol) methacrylate, (methacryloyloxy)ethyl]dimethylammonio]propionate, 2-hydroxyethyl methacrylate, poly(L-lactide) methacrylate, phosphobetaine methacrylate, poly(ethylene glycol) methacrylate, 1,2-ethanediol mono(2-methylpropenoate), glycol methacrylate (HEMA), and N-vinyl-2-pyrrolidinone (NVP).

Furthermore, the chemical formula for the above first hydrophilic monomer is summarized in Table 3.

TABLE 3
allyl alcohol

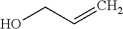

2-(dimethylamino)ethyl
methacrylate

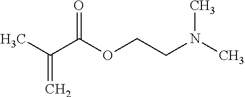

(dimethylamino)propyl]
methacrylamide

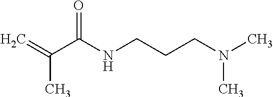

2-methyl-2-propen-1-ol

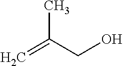

2-(dimethylamino)ethyl
acrylate

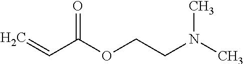

hydroxypropyl
methacrylate

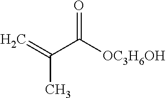

2-allylethyl alcohol

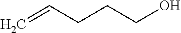

4-penten-2-ol

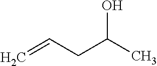

hydroxypropyl
methacrylate

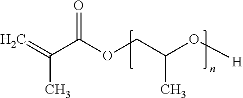

3-methyl-2-buten-1-ol

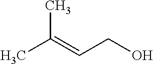

2-hydroxypropyl
methacrylamide

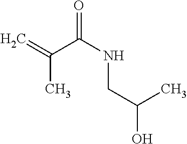

PLA methacrylate

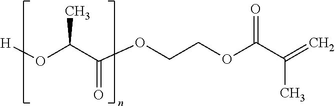

trans,trans-2,4-Hexadien-1-ol

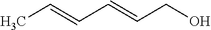

poly(ethylene glycol)
methacrylate

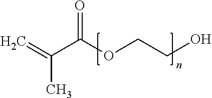

phosphobetaine
methacrylate
(PBMA)

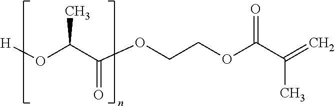

-3-Sulfopropyl-N,N-
dimethyl ammonium)ethyl
methacrylate, (SBMA)

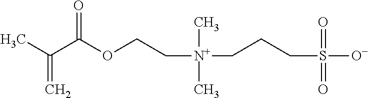 [SMILES: C=C(C)C(=O)OCC[N+](C)(C)CCCS(=O)(=O)[O-]]

methacryloyloxy)ethyl]
dimethylammonio]
propionate(CBMA)

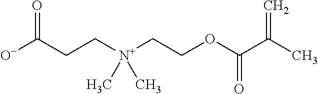 [SMILES: C=C(C)C(=O)OCC[N+](C)(C)CCC(=O)[O-]]

poly(ethylene glycol)
methacrylate(PEGMA)

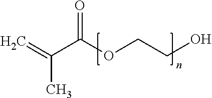

N,N-dimethylacrylamide

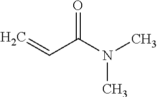

2-hydroxyethyl
methacrylate

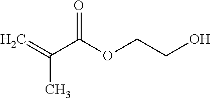

polyvinylpyrrolidone
cross-linked

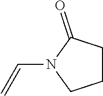

poly(ethylene glycol)
methacrylate

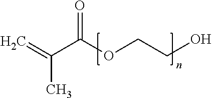

From the above mention, one aspect of the present invention is that the polymer material is highly hydrophilic and oxygen permeable, and furthermore, optical stability and chemical endurance are enhanced by IPDI, particularly, weather, abrasion and hydrolysis endurance. As a result, the polymer material of the present invention is suitably applied to high end polyurethane coating and elastomer.

Another aspect of the present invention is that when SBMA and CBMA listed at table 2 are processed by the second hydrophilic grafting, SBMA and CBMA as zwitterionic monomers can self-combine and self-assemble with balanced and charged material. For example, hyaluronic acid (HA) with negative electricity are easily aligned on the surface of the contact lens to increase the effect of moisturing and wetness.

In the present invention, the terms “3-isocyanatomethyl-3,5,5-trimethylcyclohexyl isocyanate” and “isophorone diisocyanate” can be used interchangeably.

The chemical synthesis flow chart of the hydrophilic and oxygen permeable polymer material (APEXSH01) is as follows. At Stage 1, two reaction materials are mixed and stirred at 20-50° C., including 18 g of isophorone disocyanate (IPDI/CAS number: 4098-71-9) and 35.5 g of poly (dimethylsiloxane) (poly[oxy(dimethylsilylene)], PDMS/CAS number: 156327-07-0), to induce a polymerization. The chemical formula of PDMS is as follows.

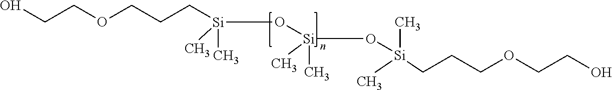

At stage 2, the first interim polymer is produced, and its chemical formula is as follows.

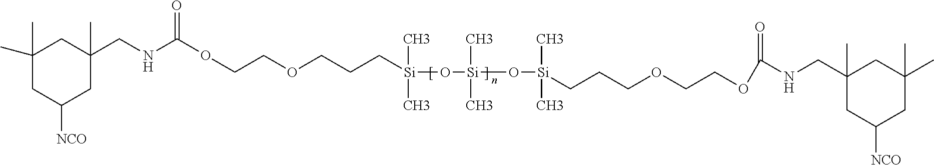

At stage 3, OCN-PDMS-PU-NCO and trans,trans-2,4-hexadien-1-ol (CAS number: 17102-64-6) are mixed and stirred to induce a polymerization, and the second interim polymer is produced. The chemical formula of the second interim polymer is as follows.

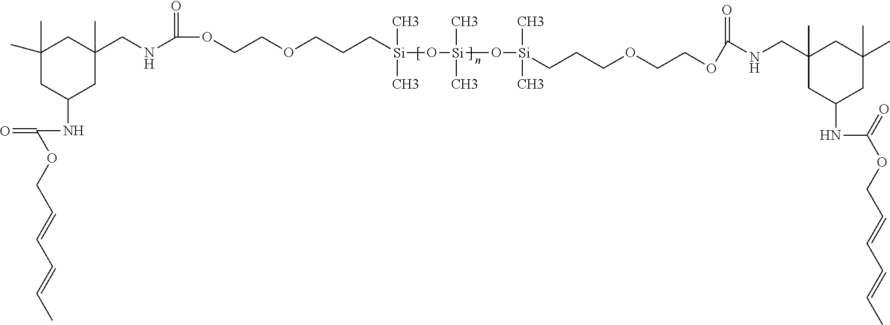

At stage 4, the post-reaction second interim polymer is stirred and mixed with 1,2-ethanediol mono(2-methylpropenoate), glycol methacrylate (HEMA) (CAS number: 868-77-9), N-vinyl-2-pyrrolidinone (NVP) (CAS number: 88-12-0), N,N-dimethylacrylamide (DMA) (CAS number: 2680-03-7), and trimethylopropane trimethacrylate (TMPTMA)(CAS number: 3290-92-4) to form the hydrophilic and oxygen permeable polymer material, APEXSH01. The chemical formula of APEXSH01 is as follows.

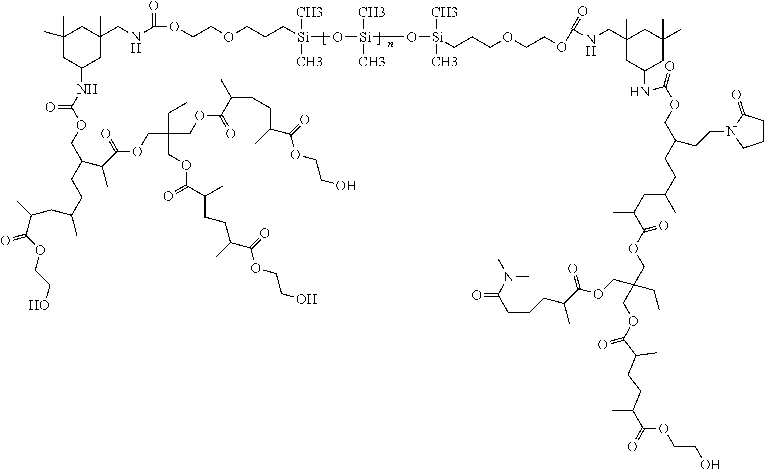

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A hydrophilic and oxygen permeable polymer material having a structure presented by formula A-(B)_{b}-C;
wherein A is alicyclic isocyanate;
B is a silicon-containing monomer modified by grafting as a repeating unit;
b is an integer of 1-30;
(B)_{b} has an average molecular weight less than or equal 5,000, and in an amount of 20-60% based on the total weight of the hydrophilic and oxygen permeable polymer material;
C is a first hydrophilic monomer and in an amount of 1-40% based on the total weight of the hydrophilic and oxygen permeable polymer material; and
the first hydrophilic monomer comprises at least one of allyl alcohol, 2-methyl-2-propen-1-ol, 2-allylethyl alcohol, 2-(dimethylamino)ethyl methacrylate, 2-(dimethylamino)ethyl acrylate, 4-penten-2-ol, N-[3-(dimethylamino)propyl]methacrylamide, hydroxypropyl methacrylate, poly(propylene glycol) methacrylate, 3-methyl-2-buten-1-ol, trans,trans-2,4-hexadien-1-ol, 2-hydroxypropyl methacrylamide, poly(L-lactide) methacrylate, poly(ethylene glycol) methacrylate, 1,2-ethanediol mono(2-methylpropenoate), glycol methacrylate (HEMA), N-vinyl-2-pyrrolidinone (NVP), N,N-dimethylacrylamide (DMA), and trimethylopropane trimethacrylate (TMPTMA);
wherein the alicyclic isocyanate comprises 3-isocyanatomethyl-3,5,5-trimethylcyclohexyl isocyanate (IPDI) represented by a formula as: 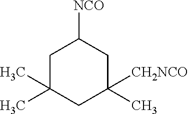
wherein (B)_{b} is polydimethylsiloxane or poly[oxy(dimethylsilylene)](PDMS);
wherein the IPDI includes two NCO groups, which have different chemical activity.

2. The hydrophilic and oxygen permeable polymer material as claimed in claim 1, wherein the silicon-containing monomer comprises at least one of 3-methacryloxypropyl tris(trimethylsiloxy)silane, 3-acryloxypropyl tris(trimethylsiloxy)silane, 3-acrylamidopropyl tris(trimethylsiloxy) silane, 3-methacrylamidopropyl tris(trimethylsiloxy)silane, 3-vinyl carbamatepropyl tris(trimethylsiloxy)silane, and (3-methacryloxy-2-hydroxyprpoxy) propylbis (trimethylsiloxy)methylsilane.

3. The hydrophilic and oxygen permeable polymer material as claimed in claim 1, further comprising a second hydrophilic monomer, and the second hydrophilic monomer comprising at least one of allyl alcohol, 2-methyl-2-propen-1-ol, 2-allylethyl alcohol, 2-(dimethylamino)ethyl methacrylate, 2-(dimethylamino)ethyl acrylate, 4-penten-2-ol. N-[3-(dimethylamino)propyl]methacrylamide, hydroxypropyl methacrylate, poly(propylene glycol) methacrylate, 3-methyl-2-buten-1-ol, trans,trans-2,4-hexadien-1-ol, N-3-sulfopropyl-N,N-dimethyl ammonium)ethyl methacrylate, N,N-dimethylacrylamide (DMA), poly(ethylene glycol) methacrylate, 2-hydroxypropyl methacrylamide, (methacryloyloxy)ethyl]dimethylammonio]propionate, 2-hydroxyethyl methacrylate, poly(L-lactide) methacrylate, phosphobetaine methacrylate, poly(ethylene glycol) methacrylate, 1,2-ethanediol mono(2-methylpropenoate), glycol methacrylate (HEMA), N-vinyl-2-pyrrolidinone (NVP), and trimethylopropane trimethacrylate (TMPTMA).

4. A method for preparing the hydrophilic and oxygen permeable polymer material as claimed in claim 1, comprising:
(a) mixing and stirring 3-isocyanatomethyl-3,5,5-trimethylcyclohexyl isocyanate (IPDI) with polydimethylsiloxane or poly[oxy(dimethylsilylene)](PDMS);
(b) producing a first interim polymer represented by a formula as: 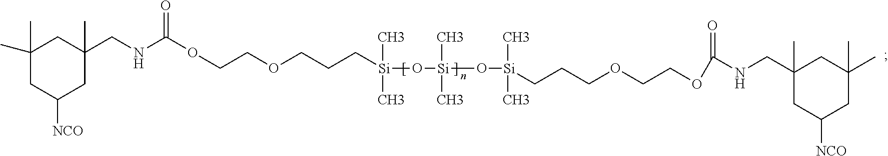
(c) mixing and stirring OCN-PDMS-PU-NCO with the first hydrophilic monomer to induce a polymerization, and a second interim polymer is produced represented by a formula as: 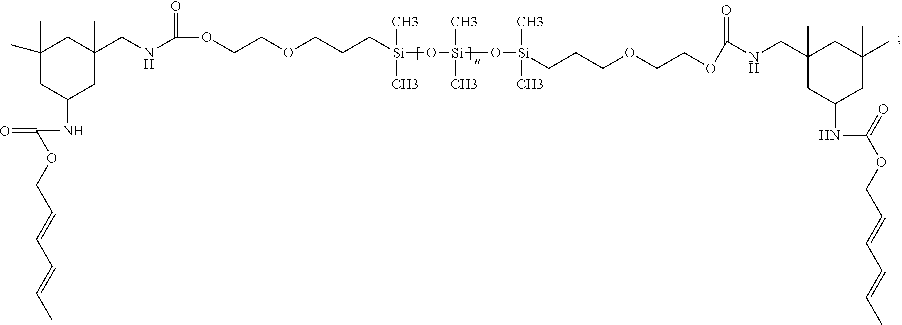
and
(d) mixing and stirring the second interim polymer with the first hydrophilic monomer to obtain the hydrophilic and oxygen permeable polymer material.

5. The method as claimed in claim 4, wherein the first hydrophilic monomer in step (c) is trans,trans-2,4-hexadien-1-ol.

6. The method as claimed in claim 5, wherein the first hydrophilic monomer in step (d) comprises at least one of 1,2-ethanediol mono(2-methylpropenoate), glycol methacrylate (HEMA), N-vinyl-2-pyrrolidinone (NVP), N,N-dimethylacrylamide (DMA), and trimethylopropane trimethacrylate (TMPTMA).

7. The method as claimed in claim 4, wherein the mixing and stirring in step (a) is performed at 20-50° C.
